(19) United States
(12) Patent Application Publication
(10) Pub. No.: US 2026/0019898 A1
(43) Pub. Date: Jan. 15, 2026

(54) METHOD, USER EQUIPMENT AND ACCESS NETWORK NODE

(71) Applicant: NEC Corporation, Minato-ku, Tokyo (JP)

(72) Inventors: Caroline LIANG, Guildford (GB); Ayesha ljaz, Guildford (GB); Neeraj Gupta, London (GB)

(73) Assignee: NEC Corporation, Minato-ku, Tokyo (JP)

(21) Appl. No.: 18/994,687

(22) PCT Filed: Sep. 7, 2023
(86) PCT No.: PCT/JP2023/032677

§ 371 Date: Jan. 15, 2025

(30) Foreign Application Priority Data
Sep. 30, 2022 (GB) 22144497

(51) Int. Cl. H04W 36/00; H04W 36/08

(52) U.S. Cl. CPC H04W 36/0085; H04W 36/08

(57) ABSTRACT

In a first example aspect, a method for a user equipment, UE, includes: receiving, from an access network node, configuration information for indicating candidate cells for layer 1 (L1) or layer 2 (L2) measurements; performing the L1 or L2 measurements based on the configuration information; and transmitting a measurement report, corresponding to the L1 or L2 measurements, to the access network node; wherein the configuration information includes information indicating a number of candidate cells to be included in the measurement report corresponding to the L1 or L2 measurement.

### TECHNICAL FIELD

The present disclosure relates to a method, a user equipment and an access network node.

### BACKGROUND ART

Under the 3rd Generation Partnership Project (3GPP) standards, a NodeB (or an ‘eNB’ in LTE, ‘gNB’ in 5G) is a base station via which communication devices (user equipment or ‘UE’) connect to a core network and communicate to other communication devices or remote servers.

### CITATION LIST

### Non Patent Literature

NPL 1: 3GPP TS 38.300 V17.1.0
NPL 2: 3GPP TS 38.300 V16.7.0
NPL 3: 3GPP TS 37.340 V16.7.0
NPL 4: 3GPP TS 22.368 V13.1.0

### SUMMARY OF INVENTION

### Technical Problem

When UE moves from one cell to another, a serving cell may need to be changed. Serving cell change may be triggered by layer 3 (L3) measurements and can be achieved using radio resource control (RRC) signalling. However, this process involves complete layer 1 (L1) and layer 2 (L2) resets, resulting in increased latency, larger overhead and longer interruption time than for beam switch mobility. For inter-cell mobility the UE may need to perform reconfiguration and downlink/uplink (DL/UL) synchronisation towards the target cell.

In order to enable more efficient handover, conditional handover may be used. A conditional handover (CHO) is a handover that is executed by the UE when one or more handover execution conditions are met. The UE may start evaluating the execution condition(s) upon receiving a CHO configuration, and may stop evaluating the execution condition(s) once a handover is executed. Conditional handover is described, for example, in TS 38.300 V17.1.0. However, there is a need for improved and more resource efficient conditional handover procedures and L1/L2 mobility. Delays in UE mobility increase the risk of radio link failure and may result in inefficient usage of radio resources.

An example of the object of the present disclosure is to provide a method, a user equipment and an access network node capable of performing more efficient handover procedures.

### Solution to Problem

In a first example aspect, a method for a user equipment, UE, includes:
receiving, from an access network node, cell information indicating candidate cells for inter-cell mobility;
performing layer 1, L1, or layer 2, L2, measurements for inter-cell mobility based on the cell information; and
transmitting a measurement report, corresponding to the L1 or L2 measurements, to the access network node;
wherein the cell information includes an indication indicating that the L1 or L2 measurements for inter-cell mobility are to be performed for a subset of the candidate cells.

In a second example aspect, a method for a user equipment, UE, includes:
receiving, from an access network node, a configuration for mobility of the UE;
starting, after receipt of the configuration, a measurement timer for layer 1, L1, or layer 2, L2, measurements for inter-cell mobility;
performing the L1 or L2 measurements; and
determining, based on a status of the measurement timer, whether to continue performing the L1 or L2 measurements.

In a third example aspect, a method for a user equipment, UE, includes:
receiving, from an access network node, filtering information indicating a filtering process or filtering parameter for use at the UE to filter measurements;
performing layer 1, L1, or layer 2, L2, measurements for inter-cell mobility;
filtering the L1 or L2 measurements based on the filtering information; and
transmitting, to the access network node, a measurement report corresponding to filtered L1 or L2 measurements.

In a fourth example aspect, a method for a user equipment, UE, includes:
receiving downlink tracking reference signals; and
estimating an uplink timing advance, UL TA, offset based on the downlink tracking reference signals.

In a fifth example aspect, a method for an access network node includes:
transmitting, to a user equipment, UE, cell information indicating candidate cells for inter-cell mobility, wherein the cell information includes an indication indicating that layer 1, L1, or layer 2, L2, measurements for inter-cell mobility are to be performed for a subset of the candidate cells; and
receiving, from the UE, a measurement report corresponding to the L1 or L2 measurements.

In a sixth example aspect, a method for an access network node includes:
transmitting, to a user equipment, UE, a configuration for mobility of the UE; and
receiving a measurement report at a time based on when the transmitting the configuration, wherein
the configuration causes the UE to start a measurement timer for layer 1, L1, or layer 2, L2, measurements is started, and to perform the L1 or L2 measurement, and
the measurement timer causes the UE to determine, based on a status of the measurement timer, whether to continue performing the L1 or L2 measurements.

In a seventh example aspect, a method for an access network node includes:
transmitting, to a user equipment, UE, filtering information indicating a filtering process or filtering parameter for use at the UE to filter measurements; and
receiving, from the UE, a measurement report corresponding to filtered measurement, and
wherein the filtered measurement corresponds to layer 1, L1, or layer 2, L2, measurements for inter-cell mobility performed by the UE and being filtered by the UE based on the filtering information.

In an eighth example aspect, a method for an access network node includes:
receiving, from the UE, a measurement report corresponding to at least one result of layer 1, L1, or layer 2, L2, measurements for inter-cell mobility;
determining a filtering process or filtering parameter to use to filter the at least one result of the L1 or L2 measurements; and
filtering the at least one result of the L1 or L2 measurements using the filtering process or filtering parameter.

In a nineth example aspect, a user equipment, UE, includes:
means for receiving, from an access network node, cell information indicating candidate cells for inter-cell mobility;
means for performing layer 1, L1, or layer 2, L2, measurements for inter-cell mobility based on the cell information; and
means for transmitting a measurement report, corresponding to the L1 or L2 measurements, to the access network node;
wherein the cell information includes an indication indicating that the L1 or L2 measurements for inter-cell mobility are to be performed for a subset of the candidate cells.

In a tenth example aspect, a user equipment, UE, includes:
means for receiving, from an access network node, a configuration for mobility of the UE;
means for starting, after receipt of the configuration, a measurement timer for layer 1, L1, or layer 2, L2, measurements for inter-cell mobility;
means for performing the L1 or L2 measurements; and
means for determining, based on a status of the measurement timer, whether to continue performing the L1 or L2 measurements.

In an eleventh example aspect, a user equipment, UE, includes:
means for receiving, from an access network node, filtering information indicating a filtering process or filtering parameter for use at the UE to filter measurements;
means for performing layer 1, L1, or layer 2, L2, measurements for inter-cell mobility;
means for filtering the L1 or L2 measurements based on the filtering information; and
means for transmitting, to the access network node, a measurement report corresponding to filtered L1 or L2 measurements.

In a twelfth example aspect, a user equipment, UE, includes:
means for receiving a downlink tracking reference signal; and
means for estimating an uplink timing advance, UL TA, offset based on the downlink tracking reference signal.

In a thirteenth example aspect, an access network node includes:
means for transmitting, to a user equipment, UE, cell information indicating candidate cells for inter-cell mobility, wherein the cell information includes an indication indicating that layer 1, L1, or layer 2, L2, measurements for inter-cell mobility are to be performed for a subset of the candidate cells; and
means for receiving, from the UE, a measurement report corresponding to the L1 or L2 measurements.

In a fourteenth example aspect, an access network node includes:
means for transmitting, to a user equipment, UE, a configuration for mobility of the UE; and
means for receiving a measurement report at a time based on when the transmitting the configuration, wherein
the configuration causes the UE to start a measurement timer for layer 1, L1, or layer 2, L2, measurements is started, and to perform the L1 or L2 measurement, and
the measurement timer causes the UE to determine, based on a status of the measurement timer, whether to continue performing the L1 or L2 measurements.

In a fifteenth example aspect, an access network node includes:
means for transmitting, to a user equipment, UE, filtering information indicating a filtering process or filtering parameter for use at the UE to filter measurements; and
means for receiving, from the UE, a measurement report corresponding to filtered measurement, and
wherein the filtered measurement corresponds to layer 1, L1, or layer 2, L2, measurements for inter-cell mobility performed by the UE and being filtered by the UE based on the filtering information.

In a sixteenth example aspect, an access network node includes:
means for receiving, from the UE, a measurement report corresponding to at least one result of layer 1, L1, or layer 2, L2, measurements for inter-cell mobility;
means for determining a filtering process or filtering parameter to use to filter the at least one result of the L1 or L2 measurements; and
means for filtering the at least one result of the L1 or L2 measurements using the filtering process or filtering parameter.

### Advantageous Effects of Invention

According to the present disclosure, it is possible to provide a method, a user equipment and an access network node capable of performing more efficient handover procedures.

### BRIEF DESCRIPTION OF DRAWINGS

Embodiments of the present disclosure will now be described, by way of example, with reference to the accompanying drawings in which:

FIG. 1 illustrates schematically a mobile (cellular or wireless) telecommunication system to which embodiments of the present disclosure may be applied;

FIG. 2 is a schematic block diagram of a mobile device;

FIG. 3 is a schematic block diagram of an access network node (e.g. base station);

FIG. 4 is a schematic block diagram of a distributed unit of RAN equipment for the telecommunication system shown in FIG. 1;

FIG. 5 is a schematic block diagram of a central unit of RAN equipment for the telecommunication system shown in FIG. 1;

FIG. 6 shows an example of Intra-CU inter-DU mobility;

FIG. 7 shows a method for L1/L2-based inter-cell mobility;

FIG. 8 shows an example of Intra-DU mobility;

FIG. 9 shows Intra-DU handover to additional PCI;

FIG. 10 shows an example of SSB blocks and CSI-RS of two cells, illustrating a handover boundary;

FIG. 11 shows an inter-cell inter-DU method;

FIG. 12 shows a gNB triggered L1 mobility method including measurement report filtering;

FIG. 13 shows an inter-cell inter-DU method including conditional handover;

FIG. 14 shows an inter-cell inter-DU method including an L1 measurement report reconfiguration;

FIG. 15 shows a flow diagram of a method that includes a timer for neighbouring cell SSB measurements;

FIG. 16 shows a flow diagram of a method that includes a measurement start/stop indication;

FIG. 17 shows a flow diagram of a method in which a measurement threshold is used;

FIG. 18 shows a flow diagram of a method that includes a list of candidate cells for inter-cell beam measurement;

FIG. 19 shows a flow diagram of a method that includes measurement report filtering; and

FIG. 20 shows a flow diagram of a method that includes estimating an uplink timing advance based on a downlink tracking reference signal.

### DESCRIPTION OF EMBODIMENTS

### Related Arts

Under the 3GPP standards, a NodeB (or an ‘eNB’ in LTE, ‘gNB’ in 5G) is a base station via which communication devices (user equipment or ‘UE’) connect to a core network and communicate to other communication devices or remote servers. End-user communication devices are commonly referred to as User Equipment (UE) which may be operated by a human or comprise automated devices. Such communication devices might be, for example, mobile communication devices such as mobile telephones, smartphones, smart watches, personal digital assistants, laptop/tablet computers, web browsers, e-book readers, connected vehicles, and/or the like. Such mobile (or even generally stationary) devices are typically operated by a user (and hence they are often collectively referred to as user equipment, ‘UE’) although it is also possible to connect Internet of Things (IoT) devices and similar Machine Type Communications (MTC) devices to the network. For simplicity, the present application will use the term base station to refer to any such base stations and use the term mobile device or UE to refer to any such communication device.

The latest developments of the 3GPP standards are the so-called ‘5G’ or ‘New Radio’ (NR) standards which refer to an evolving communication technology that is expected to support a variety of applications and services such as MTC, IoT/Industrial IoT (IIoT) communications, vehicular communications and autonomous cars, high resolution video streaming, smart city services, and/or the like. 3GPP intends to support 5G by way of the so-called 3GPP Next Generation (NextGen) radio access network (RAN)/radio access technology (RAT) and the 3GPP NextGen core (NGC) network. Various details of 5G networks are described in, for example, the ‘NGMN 5G White Paper’ V1.0 by the Next Generation Mobile Networks (NGMN) Alliance, which document is available from https://www.ngmn.org/5g-white-paper.html.

### Problem of Related Arts

When UE moves from one cell to another, a serving cell may need to be changed. Serving cell change may be triggered by layer 3 (L3) measurements and can be achieved using radio resource control (RRC) signalling. However, this process involves complete layer 1 (L1) and layer 2 (L2) resets, resulting in increased latency, larger overhead and longer interruption time than for beam switch mobility. For inter-cell mobility the UE may need to perform reconfiguration and downlink/uplink (DL/UL) synchronisation towards the target cell.

In order to enable more efficient handover, conditional handover may be used. A conditional handover (CHO) is a handover that is executed by the UE when one or more handover execution conditions are met. The UE may start evaluating one or more execution conditions upon receiving a CHO configuration, and may stop evaluating the one or more execution conditions once a handover is executed. Conditional handover is described, for example, in 3GPP Technical Specification (TS) 38.300 V17.1.0. However, there is a need for improved and more resource efficient conditional handover procedures and L1/L2 mobility. Delays in UE mobility increase the risk of radio link failure and may result in inefficient usage of radio resources. In particular, there is a need for L1/L2 mobility enhancements for enabling serving cell change via L1/L2 signalling, to reduce the latency, overhead and interruption time.

More generally, there is a need for improved mechanisms and procedures for L1/L2 based inter-cell mobility. These mechanisms and procedures include, but are not limited to, inter-cell beam management, L1 measurement and reporting, and beam indications.

The present disclosure seeks to provide methods and associated apparatus that address or at least ameliorate (at least some of) the above-described issues. The present disclosure relates to a wireless communication system and devices thereof operating according to the 3GPP standards or equivalents or derivatives thereof. The disclosure has particular, but not exclusive, relevance to improvements related to inter-cell beam management procedures.

### Description of Aspects

The present disclosure describes multiple aspects and variants for each instance. These aspects and variants can be arbitrarily combined with each other.

In a first aspect the present disclosure provides a method for a user equipment, UE, the method including: receiving, from an access network node, a configuration for mobility of the UE; starting, after receipt of the configuration, a measurement timer for periodic layer 1, L1, measurements for inter-cell mobility; performing the periodic L1 measurements; and determining, based on the status of the measurement timer, whether to continue performing the periodic L1 measurements.

The method may include: upon expiry of the measurement timer, and if no handover has been triggered, ceasing performance of the periodic measurements for the L1 or layer 2, L2, mobility procedure.

The periodic L1 measurements may be SSB measurements for an L1/L2 mobility procedure. The method may further include transmitting, to the access network node, a measurement report that indicates one or more measurements obtained in the periodic L1 measurements.

The method may further include: receiving, from the access network node, a timer indication that indicates that the measurement timer is to be started, stopped, or restarted; and starting, stopping, or restarting the measurement timer based on the timer indication.

The method may include: receiving, from an access network node, a measurement indication that indicates whether periodic layer 1, L1, measurements for inter-cell mobility are to be performed by the UE; and if the measurement indication indicates that periodic L1 measurements are to be performed by the UE, performing the periodic L1 measurements and transmitting a corresponding measurement report to the access network node.

The measurement indication may indicate that periodic L1 measurements are to be performed for one or more neighbouring cells; and the method may include performing the periodic L1 measurements for the one or more neighbouring cells.

The measurement indication may indicate that periodic L1 measurements are not to be performed for one or more neighbouring cells; and the method may include not performing, or ceasing performance of, periodic L1 measurements for the one or more neighbouring cells.

In a second aspect the present disclosure provides a method for a user equipment, UE, the method including: receiving, from an access network node, candidate cell information that indicates candidate cells for inter-cell mobility; performing periodic layer 1, L1, measurements for inter-cell mobility based on the candidate cell information; and transmitting a measurement report, corresponding to the periodic L1 measurements, to the access network node; wherein the candidate cell information includes an indication that L1 measurements for inter-cell mobility are to be performed for a subset of the candidate cells.

The candidate cell information may include an indication of a number of candidate cells for which the performing periodic L1 measurements may be performed simultaneously by the UE.

The candidate cell information may include a measurement priority for each of the candidate cells; and the method may include selecting a subset of the candidate cells based on the measurement priority, and performing the periodic L1 measurements for the subset of the candidate cells.

The measurement report may include a corresponding cell index or beam index associated with the periodic L1 measurement.

In a third aspect the present disclosure provides a method for a user equipment, UE, the method including: receiving, from an access network node, filtering information indicating a filtering process or filtering parameter for use at the UE to filter a measurement; performing periodic layer 1, L1, measurements for inter-cell mobility; filtering a measurement obtained in the performing periodic L1 measurements based on the filtering information; and transmitting, to the access network node, a measurement report corresponding to the filtered measurement.

The filtering information may include at least one of a filtering formula or a number of measurements to average.

In a fourth aspect the present disclosure provides a method for a user equipment, UE, the method including: receiving downlink tracking reference signals; and estimating an uplink timing advance, UL TA, offset based on the downlink tracking reference signals.

The downlink tracking reference signals may include downlink tracking reference signals for a source cell and a candidate target cell for an inter-cell mobility procedure.

In a fifth aspect the present disclosure provides a method for an access network node, the method including: transmitting, to a user equipment, UE, a measurement indication that indicates whether periodic layer 1, L1, measurements for inter-cell mobility are to be performed by the UE; and if the measurement indication indicates that periodic L1 measurements for inter-cell mobility are to be performed, receiving a corresponding measurement report from the UE.

The method may further include: transmitting a mobility configuration to the UE; and determining, based on a time since the mobility configuration was transmitted to the UE, whether to transmit the measurement indication including an indication that periodic L1 measurements for inter-cell mobility are to be performed by the UE.

The method may further include: obtaining layer 3, L3, reference signal received power, RSRP, measurements; and determining, based on the RSRP measurements, whether to transmit the measurement indication including an indication that periodic L1 measurements for inter-cell mobility are to be performed by the UE.

The method may further include: receiving, from the UE, a measurement result corresponding to a neighbouring cell measurement performed at the UE; and determining, based on the measurement result, whether to transmit the measurement indication including an indication that periodic L1 measurements for inter-cell mobility are to be performed by the UE.

Transmitting the measurement indication may include transmitting the measurement indication to the UE via physical downlink control channel, PDCCH.

The method may further include: receiving, from the UE, a measurement result corresponding to a neighbouring cell measurement performed at the UE; comparing the measurement result to a threshold value; and determining, based on the comparison between the measurement result and the threshold value, whether to transmit the measurement indication including an indication that periodic L1 measurements for inter-cell mobility are to be performed by the UE.

The measurement result may include a signal strength or signal quality measured by the UE; and comparing the measurement result to a threshold value may include comparing the signal strength or the signal quality to a respective threshold signal strength or threshold signal quality.

The method may include transmitting the measurement indication, including an indication that periodic L1 measurements for inter-cell mobility are to be performed by the UE, when the signal strength is greater than the threshold signal strength, or when the signal quality is greater than the threshold signal quality.

The method may include transmitting the measurement indication, including an indication that periodic L1 measurements for inter-cell mobility are to be performed by the UE, when the signal strength is less than the threshold signal strength, or when the signal quality is less than the threshold signal quality.

The threshold value may correspond to a signal strength or signal quality measurement previously reported to the base station by the UE.

The measurement indication may include an indication of whether a measurement timer for periodic L1 measurements for inter-cell mobility is to be started, stopped or restarted at the UE.

In a sixth aspect the present disclosure provides a method for an access network node, the method including: transmitting, to a user equipment, UE, candidate cell information that indicates candidate cells for inter-cell mobility, wherein the candidate cell information includes an indication that layer 1, L1, measurements for inter-cell mobility are to be performed for a subset of the candidate cells; and receiving, from the UE, a measurement report corresponding to the periodic L1 measurements.

The candidate cell information may include an indication of a number of candidate cells for which the performing periodic L1 measurements may be performed simultaneously by the UE.

The candidate cell information may include a measurement priority for each of the candidate cells; and the measurement priority may be for use by the UE to select a subset of the candidate cells and to perform the periodic L1 measurements for the subset of the candidate cells.

The method may further include determining, based on a capability of the UE or a power saving requirement of the UE whether to include an indication that L1 measurements for inter-cell mobility are to be performed for a particular candidate cell in the candidate cell information.

In a seventh aspect the present disclosure provides a method for an access network node, the method including: transmitting, to a user equipment, UE, filtering information indicating a filtering process or filtering parameter for use at the UE to filter a measurement; and receiving, from the UE, a measurement report corresponding to the filtered measurement.

The method may further include: obtaining handover information indicating a handover performance characteristic of the UE; and determining a filtering process or filtering parameter to include in the filtering information based on the handover performance characteristic.

The handover performance characteristic may include at least one of: a handover failure rate of the UE; an occurrence of pingpong handover; rapid handover; a handover that occurred too early; a handover that occurred too late; or a handover that occurred to an incorrect cell.

In an eighth aspect the present disclosure provides a method for an access network node, the method including: receiving, from the UE, a measurement report corresponding to at least one measurement; determining a filtering process or filtering parameter to use to filter the at least one measurement included in the measurement report; and filtering the at least one measurement using the determined filtering process or filtering parameter.

The method may further include: obtaining handover information indicating a handover performance characteristic of the UE; and determining the filtering process or filtering parameter based on the handover performance characteristic.

The handover performance characteristic may include at least one of: a handover failure rate of the UE; an occurrence of pingpong handover; rapid handover; a handover that occurred too early; a handover that occurred too late; or a handover that occurred to an incorrect cell.

In a ninth aspect the present disclosure provides a user equipment, UE, including: means for receiving, from an access network node, a configuration for mobility of the UE; means for starting, after receipt of the configuration, a measurement timer for periodic layer 1, L1, measurements for inter-cell mobility; means for performing the periodic L1 measurements; and means for determining, based on the status of the measurement timer, whether to continue performing the periodic L1 measurements.

In a tenth aspect the present disclosure provides a user equipment, UE, including: means for receiving, from an access network node, a measurement indication that indicates whether periodic layer 1, L1, measurements for inter-cell mobility are to be performed by the UE; and means for performing, if the measurement indication indicates that periodic L1 measurements are to be performed by the UE, the periodic L1 measurements, and means for transmitting a corresponding measurement report to the access network node.

In an eleventh aspect the present disclosure provides a user equipment, UE, including: means for receiving, from an access network node, candidate cell information that indicates candidate cells for inter-cell mobility; means for performing periodic layer 1, L1, measurements for inter-cell mobility based on the candidate cell information; and means for transmitting a measurement report, corresponding to the periodic L1 measurements, to the access network node; wherein the candidate cell information includes an indication that L1 measurements for inter-cell mobility are to be performed for a subset of the candidate cells.

In a twelfth aspect the present disclosure provides a user equipment, UE, including: means for receiving, from an access network node, filtering information indicating a filtering process or filtering parameter for use at the UE to filter a measurement; means for performing periodic layer 1, L1, measurements for inter-cell mobility; means for filtering a measurement obtained in the performing periodic L1 measurements based on the filtering information; and means for transmitting, to the access network node, a measurement report corresponding to the filtered measurement.

In a thirteenth aspect the present disclosure provides a user equipment, UE, including means for receiving a downlink tracking reference signal; and means for estimating an uplink timing advance, UL TA, offset based on the downlink tracking reference signal.

In a fourteenth aspect the present disclosure provides an access network node including: means for transmitting, to a user equipment, UE, a measurement indication that indicates whether periodic layer 1, L1, measurements for inter-cell mobility are to be performed by the UE; and means for receiving, if the measurement indication indicates that periodic L1 measurements for inter-cell mobility are to be performed, a corresponding measurement report from the UE.

In a fifteenth aspect the present disclosure provides an access network node including: means for transmitting, to a user equipment, UE, candidate cell information that indicates candidate cells for inter-cell mobility, wherein the candidate cell information includes an indication that layer 1, L1, measurements for inter-cell mobility are to be performed for a subset of the candidate cells; and means for receiving, from the UE, a measurement report corresponding to the periodic L1 measurements.

In a sixteenth aspect the present disclosure provides an access network node including: means for transmitting, to a user equipment, UE, filtering information indicating a filtering process or filtering parameter for use at the UE to filter a measurement; and means for receiving, from the UE, a measurement report corresponding to the filtered measurement.

In a seventeenth aspect the present disclosure provides an access network node including: means for receiving, from the UE, a measurement report corresponding to at least one measurement; means for determining a filtering process or filtering parameter to use to filter the at least one measurement included in the measurement report; and means for filtering the at least one measurement using the determined filtering process or filtering parameter.

### DETAILED DESCRIPTION

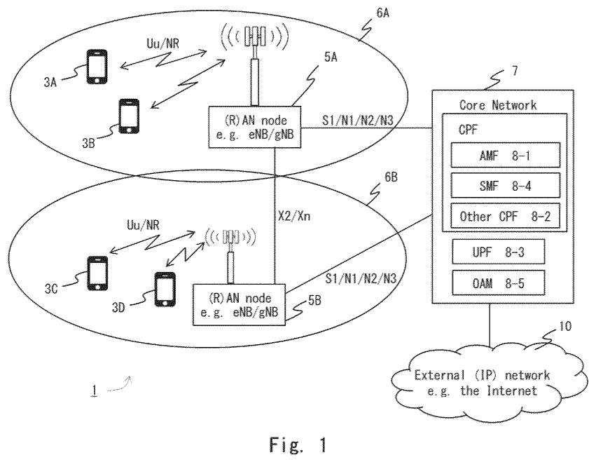

FIG. 1 illustrates schematically a mobile (cellular or wireless) telecommunication system 1 to which embodiments of the present disclosure may be applied.

In this system 1, users of mobile devices 3 (UEs) can communicate with each other and other users via base stations 5 (and other access network nodes) and a core network 7 using an appropriate 3GPP radio access technology (RAT), for example, an Evolved Universal Terrestrial Radio Access (E-UTRA), a 5G RAT, and/or later generation Radio Access Technologies. It will be appreciated that a number of base stations 5 form a (radio) access network or (R)AN. As those skilled in the art will appreciate, whilst four mobile devices 3A, 3B, 3C and 3D and two base stations 5A and 5B are shown in FIG. 1 for illustration purposes, the system, when implemented, will typically include other base stations/(R)AN nodes 5 and mobile devices (UEs) 3.

Each base station 5 controls one or more associated cells 6 (either directly or via other nodes such as home base stations, relays, remote radio heads, distributed units, and/or the like). A base station 5 that supports Next Generation/5G protocols may be referred to as a ‘gNB’. It will be appreciated that some base stations 5 may be configured to support both 4G and 5G, and/or any other 3GPP or non-3GPP communication protocols. It will be appreciated that a number of base stations 5 form a (radio) access network or (R)AN.

### <User Equipment (UE)>

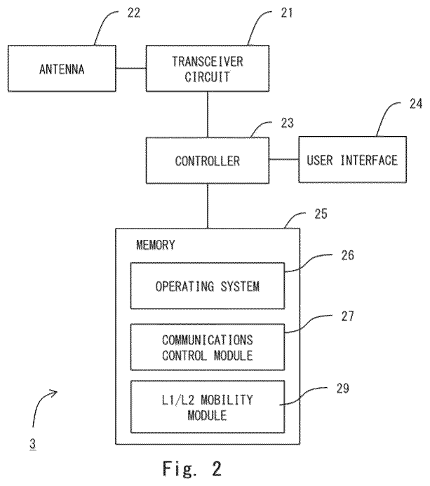

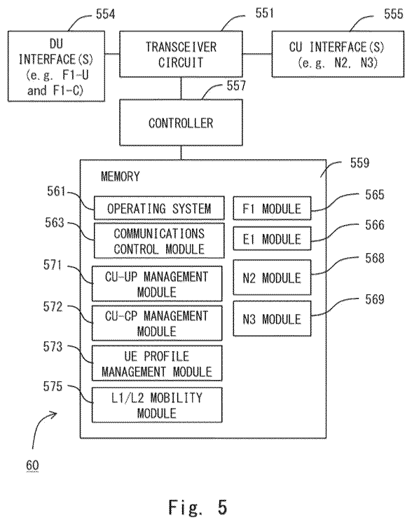

FIG. 2 is a block diagram illustrating the main components of the mobile device (UE) 3 shown in FIG. 1. As shown, the UE 3 includes a transceiver circuit 21 which is operable to transmit signals to and to receive signals from one or more connected nodes via one or more antennas 22. Although not necessarily shown in FIG. 5, the UE 3 will of course have all the usual functionality of a conventional mobile device (such as a user interface 24) and this may be provided by any one or any combination of hardware, software and firmware, as appropriate. A controller 23 controls the operation of the UE 3 in accordance with software stored in a memory 25. The software may be pre-installed in the memory 25 and/or may be downloaded via the telecommunication system 1 or from a removable data storage device (RMD), for example. The software includes, among other things, an operating system 26, a communications control module 27, and an L1/L2 mobility module 29.

The communications control module 27 is responsible for handling (generating/sending/receiving) signalling messages and uplink/downlink data packets between the UE 3 and other nodes, including (R)AN nodes 5, and core network nodes. The signalling may comprise control signalling (such as RRC signalling) related to configuring and assisting cell reselection by the UE 3.

The L1/L2 mobility module 29 is responsible for controlling L1/L2 mobility. For example, the L1/L2 mobility module 29 may be configured to perform one or more measurements for L1/L2 mobility, or to select a candidate cell for handover. It will be appreciated that the L1/L2 mobility module 29 may be configured to perform control in any of the L1/L2 mobility methods described below.

### <Base Station/Gateway (Access Network Node)>

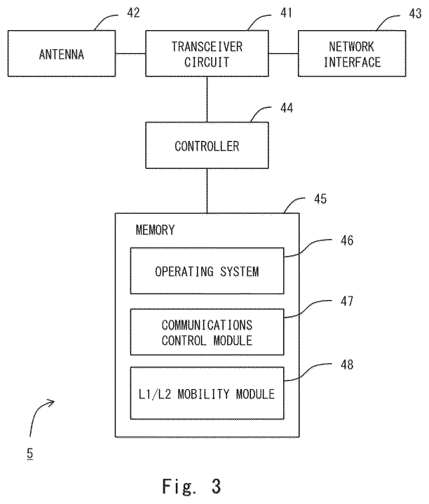

FIG. 3 is a block diagram illustrating the main components of the gateway/base station 5 shown in FIG. 1 (a base station (gNB) or a similar access network node, the base station need not necessarily be a gNB 5). As shown, the gateway/base station 5 includes a transceiver circuit 41 which is operable to transmit signals to and to receive signals from one or more connected UEs 3 via one or more antennas 42 and to transmit signals to and to receive signals from other network nodes (either directly or indirectly) via a network interface 43. The network interface 43 typically includes an appropriate base station-base station interface (such as X2/Xn) and an appropriate base station-core network interface (such as S1/NG-C/NG-U). A controller 44 controls the operation of the base station 5 in accordance with software stored in a memory 45. The software may be pre-installed in the memory 45 and/or may be downloaded via the telecommunication system1 or from a removable data storage device (RMD), for example. The software includes, among other things, an operating system 46, a communications control module 47, and an L1/L2 mobility module 48.

The communications control module 47 is responsible for handling (generating/sending/receiving) signalling between the base station 5 and other nodes, such as the UE 3 and core network nodes. The signalling may comprise control signalling (such as RRC signalling) related to configuring and assisting cell reselection by the UE 3.

The L1/L2 mobility module 48 is responsible for controlling an L1/L2 mobility procedure. For example, the L1/L2 mobility module 48 may control the transmission of a set of candidate cells to a UE 3, or may control one or more measurements to be performed by the UE for L1/L2 mobility. It will be appreciated that the L1/L2 mobility module 48 may be configured to perform control in any of the L1/L2 mobility methods described below.

The present disclosure relates to a base station (referred to as a ‘distributed’ base station or gNB) that is split between one or more distributed units (DUs) 50 and a central unit (CU) 60, with a CU 60 typically performing higher level functions and communication with the next generation core and with the DU 50 performing lower level functions and communication over an air interface with UEs 3 in the vicinity (i.e. in a cell operated by the gNB 5). A distributed gNB 5 includes the following functional units:
gNB Central Unit (gNB-CU): a logical node hosting Radio Resource Control (RRC), Service Data Adaptation Protocol (SDAP) and Packet Data Convergence Protocol (PDCP) layers of the gNB (or RRC and PDCP layers of an en-gNB) that controls the operation of one or more gNB-DUs. The gNB-CU terminates the so-called F1 interface connected with the gNB-DU.
gNB Distributed Unit (gNB-DU): a logical node hosting Radio Link Control (RLC), Medium Access Control (MAC) and Physical (PHY) layers of the gNB or en-gNB, and its operation is partly controlled by gNB-CU. One gNB-DU supports one or multiple cells. One cell is supported by only one gNB-DU. The gNB-DU terminates the F1 interface connected with the gNB-CU.
gNB-CU-Control Plane (gNB-CU-CP): a logical node hosting the RRC and the control plane part of the PDCP protocol of the gNB-CU for an en-gNB or a gNB. The gNB-CU-CP terminates the so-called E1 interface connected with the gNB-CU-UP and the F1-C (F1 control plane) interface connected with the gNB-DU.
gNB-CU-User Plane (gNB-CU-UP): a logical node hosting the user plane part of the PDCP protocol of the gNB-CU for an en-gNB, and the user plane part of the PDCP protocol and the SDAP protocol of the gNB-CU for a gNB. The gNB-CU-UP terminates the E1 interface connected with the gNB-CU-CP and the F1-U (F1 user plane) interface connected with the gNB-DU.

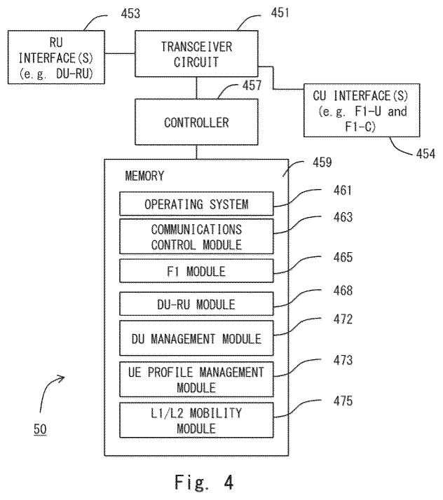

It will be appreciated that when a distributed base station or a similar control plane-user plane (CP-UP) split is employed, the base station may be split into separate control-plane and user-plane entities, each of which may include an associated transceiver circuit, antenna, network interface, controller, memory, operating system, and communications control module. When the base station 5 comprises a distributed base station, the network interface (reference numeral 43 in FIG. 4) also includes an E1 interface and an F1 interface (F1-C for the control plane and F1-U for the user plane) to communicate signals between respective functions of the distributed base station. In this case, the communications control module is also responsible for communications (generating, sending, and receiving signalling messages) between the control-plane and user-plane parts of the base station.

### <RAN Equipment (DU)>

FIG. 4 is a schematic block diagram illustrating the main components of a DU 50 that may be used as part of the RAN equipment 5 for the telecommunication system 1 shown in FIG. 1. As shown, the DU 50 has a transceiver circuit 451 for: transmitting signals to, and for receiving signals from, the communication devices (such as UEs 3) via the radio unit (RU) and the associated DU-RU interface 453; and for transmitting signals to, and for receiving signals from, the CU 60 of the RAN equipment 5 via a CU interface 454 (e.g. comprising an F1 interface which may be split into an F1-U and an F1-C interface for user plane and control plane signalling respectively).

The DU 50 has a controller 457 to control the operation of the DU 50. The controller 457 is associated with a memory 459. Software may be pre-installed in the memory 459 and/or may be downloaded via the telecommunication system 1 or from a removable data storage device (RMD) for example. The controller 457 is configured to control the overall operation of the DU 50 by, in this example, program instructions or software instructions stored within memory 459.

As shown, these software instructions include, among other things, an operating system 461, a communications control module 463, an F1 module 465, a DU-RU module 468, a DU management module 472, a UE profile management module 473 and an L1/L2 mobility module 475. The functions of the L1/L2 mobility module are the same as described above with reference to FIG. 3.

The communications control module 463 is operable to control the communication between the DU 50 and one or more RUs 5a (and hence between the DU 50 and the UE 3), and between the DU 50 and the CU 60. The communications control module 463 is configured for the overall control of the reception of signals corresponding to uplink communications from the UE 3 and for handling the transmission of downlink communications destined for the UE 3.

The F1 module 465 is responsible for the appropriate processing of signals received from, or transmitted to, the CU 60 via one or more CU (e.g. F1) interfaces 454. These signals may be separated into: user plane signals received from, or transmitted to, the CU-UP part of the CU 60 via the F1-U interface; and control plane signals received from, or transmitted to, the CU-CP part of the CU 60 via the F1-C interface.

The DU-RU module 468 is responsible for the appropriate processing of signals received from, or transmitted to, the RU via one or more RU (e.g. DU-RU) interfaces 453.

The DU management module 472 is responsible for managing the overall operation of the DU 50 and the overall performance of the tasks required of the DU 50. These tasks include, among other things, the generation and transmission of appropriate messages using appropriate signalling application protocols, depending on the functional split between the RU, DU 50 and CU 60, such as interpretation of received MAC signalling and the generation of MAC signalling for transmission.

The UE profile management module 473 is responsible for carrying out functions related to the UE profile including (where applicable): the reception and storage of the UE profile or related assistance/preference information from the UE 3 or from elsewhere in the network; the determination (where applicable) of appropriate mobility specific configurations, based on the UE profile/assistance information/preference information, for implementation at the UE 3 and/or RAN equipment; and/or the provision of configuration information (where applicable) for configuring the UE appropriately with mobility based configurations. It will be appreciated that, depending on implementation, the gNB-DU may not implement at least some of these features.

### {RAN Equipment (CU)}

FIG. 5 is a schematic block diagram illustrating the main components of the CU 60 of the RAN equipment for the telecommunication system 1 shown in FIG. 1. As shown, the CU 60 has a transceiver circuit 551 for: transmitting signals to, and for receiving signals from, the DU 50 via one or more DU interfaces 554 (e.g. comprising an F1 interface which may be split into an F1-U and an F1-C interface for user plane and control plane signalling respectively); and for transmitting signals to, and for receiving signals from, the functions of the core network 7 via one or more core network interfaces 555 (e.g. comprising the N2 and N3 interfaces or the like).

The CU 60 has a controller 557 to control the operation of the CU 60. The controller 557 is associated with a memory 559. Software may be pre-installed in the memory 559 and/or may be downloaded via the communications system 1 or from a removable data storage device (RMD) for example. The controller 557 is configured to control the overall operation of the CU 60 by, in this example, program instructions or software instructions stored within memory 559.

As shown, these software instructions include, among other things, an operating system 561, a communications control module 563, an F1 module 565, an E1 module 566, an N2 module 568, an N3 module 569, a CU-UP management module 571, a CU-CP management module 572, a UE profile management module 573, and an L1/L2 mobility module 575. The functions of the L1/L2 mobility module 575 are the same as described above with reference to FIG. 3.

The communications control module 563 is operable to control the communication between the CU 60 and one or more DUs 50 (and hence between the CU 60 and the UE 3), and between the CU 60 and the core network 7. The communications control module 563 is configured for the overall control of the reception of signals corresponding to uplink communications from the UE 3 and for handling the transmission of downlink communications destined for the UE 3.

The F1 module 565 is responsible for the appropriate processing of signals received from, or transmitted to, the DU 50 via one or more DU (e.g. F1) interfaces 554. These signals may be separated into: user plane signals received at, or transmitted by, the CU-UP part of the CU 5c via the F1-U interface; and control plane signals received at, or transmitted by, the CU-CP part of the CU 5c via the F1-C interface.

The E1 module 566 is responsible for the appropriate processing of signals transmitted between the CU-UP part of the CU 60 and the CU-CP part of the CU 60 via the corresponding internal CU interface (e.g. E1).

The N2 module 568 is responsible for the appropriate processing of signals received from, or transmitted to, the AMF 8-1 via the corresponding one or more core network interfaces (e.g. N2) 555.

The N3 module 569 is responsible for the appropriate processing of signals received from, or transmitted to, one or more core network user plane functions via the corresponding one or more core network interfaces (e.g. N3) 555.

The CU-UP management module 571 is responsible for managing the overall operation of the CU-UP part of the CU 60 and the overall performance of the tasks required of the CU-UP.

The CU-CP management module 572 is responsible for managing the overall operation of the CU-CP part of the CU 60 and the overall performance of the tasks required of the CU-CP. These tasks include, among other things, the generation and transmission of appropriate messages using appropriate signalling application protocols, depending on the functional split between the RU, DU 50 and CU 60, such as interpretation of received RRC signalling and the generation of RRC signalling for transmission.

The UE profile management module 573 is responsible for carrying out functions related to the UE (mobility) profile including (where applicable): the reception and storage of the UE profile or related assistance/preference information from the UE 3 or from elsewhere in the network; the determination of appropriate mobility specific configurations, based on the UE profile/assistance information/preference information, for implementation at the UE 3 and/or RAN equipment 5; and/or the provision of configuration information for configuring the UE appropriately with mobility based configurations. It will be appreciated that, depending on implementation, the gNB-CU 60 may not implement at least some of these features.

The mobile device 3 and its serving base station 5 are connected via an appropriate air interface (for example the so-called ‘NR’ air interface, the ‘Uu’ interface, and/or the like).

The core network 7 (e.g. the EPC in case of LTE or the NGC in case of NR/5G) typically includes logical nodes (or ‘functions’) for supporting communication in the telecommunication system 1, and for subscriber management, mobility management, charging, security, call/session management (amongst others). For example, the core network 7 of a ‘Next Generation’/5G system will include user plane entities and control plane entities, such as one or more control plane functions (CPFs) and one or more user plane functions (UPFs) 8-3. The one or more control plane functions (CPFs) include a control plane function 8-1 that is responsible for handling connection and mobility tasks for the mobile devices 3, such as the so-called Access and Mobility Management Function (AMF) in 5G, or the Mobility Management Entity (MME) in 4G. The one or more control plane functions (CPFs) also include a control plane function that is 8-4 that is responsible for handling communication sessions for the mobile devices 3 such as session establishment, modification and release (such as the Session Management Function (SMF)), and may also include one or more additional control plane functions 8-2. The Operations, Administration and Maintenance (OAM) function 8-5 may be implemented in software in one or more 5G CN nodes. The core network 7 is coupled to a data network 10, such as the Internet or a similar Internet Protocol (IP) based network.

When the UE 3 initially establishes a radio resource control (RRC) connection with a base station 5 via a cell it registers with an appropriate core network node 8-1 (e.g, AMF, MME). The UE 3 is in the so-called RRC connected state and an associated UE context is maintained by the network. When the UE 3 is in the so-called RRC idle or in the RRC inactive state, it selects an appropriate cell for camping so that the network is aware of the approximate location of the UE 3 (although not necessarily on a cell level).

### <L1/L2 Mobility and Conditional Handover>

A Conditional Handover (CHO) is a handover that is executed by the UE 3 when one or more handover execution conditions are met. The UE 3 starts evaluating one or more execution conditions upon receiving a CHO configuration, and stops evaluating the one or more execution conditions once the handover is executed. The execution conditions may be based, for example, on measurements performed by the UE 3 of reference signal received power (RSRP), reference signal received quality (RSRQ), RSRP and signal to noise interference ratio (RSRP-SINR). For L1/L2 mobility, handover is initiated based on L1/L2 measurement results.

An example of CHO will now be described. A ‘CHO candidate cell’ is a candidate cell for CHO, and has a corresponding CHO configuration. The CHO configuration comprises the configuration of one or more CHO candidate cells generated by the candidate base stations 5 and one or more execution conditions generated by the source base station 5.

An execution condition may comprise, for example, one or two trigger condition, which may also be referred to as CHO events.

As in intra-NR RAN handover, in intra-NR RAN CHO, the preparation and execution phase of the conditional handover procedure may be performed without involvement of the 5GC; i.e. preparation messages are directly exchanged between base stations 5. The release of the resources at the source base station during the conditional handover completion phase is triggered by the target base station 5.

In a CHO method, the source base station 5 may determine that CHO should be used. The source base station 5 may request CHO for one or more candidate cells belonging to one or more candidate base stations 5. A CHO request message can then be sent for each candidate cell.

The candidate base stations 5 send a CHO response, including a configuration of one or more CHO candidate cells, to the source base station 5. The CHO response message may be sent for each candidate cell.

The source base station 5 may send an RRC Reconfiguration message to the UE 3, containing the configuration of one or more CHO candidate cells and one or more CHO execution conditions. The UE 3 may send an RRC Reconfiguration Complete message to the source base station 5. If early data forwarding is applied, the source base station 5 may sends an early status transfer message.

The UE 3 maintains connection with the source base station after receiving CHO configuration, and starts evaluating the CHO execution conditions for one or more candidate cells. If at least one CHO candidate cell satisfies the corresponding CHO execution condition, the UE 3 detaches from the source base station, applies the stored corresponding configuration for that selected candidate cell, synchronises to that candidate cell and completes the RRC handover procedure by sending an RRC Reconfiguration Complete message to the target base station. The UE 3 releases stored CHO configurations after successful completion of RRC handover procedure.

A target base station 5 sends the handover success message to the source base station 5 to inform that the UE 3 has successfully accessed the target cell. In return, the source base station 5 sends a SN STATUS TRANSFER message.

The source base station 5 can then send a handover cancel message toward the other signalling connections or other candidate target base stations, if any, to cancel CHO for the UE 3.

Conditional configurations for a conditional handover may be provided as a ‘delta configuration’ with respect to the configuration of the serving cell. In other words, parameters and setting for the conditional configuration may be indicated by indicating the differences between the conditional configuration and the configuration of the serving cell.

A UE 3 may be configured to indicate to another entity in the telecommunication system 1 that the UE 3 supports conditional handover by, for example, transmitting a signal that includes an indication in a conditional handover field or information element.

A CHO candidate cell list can be used to indicate a list of candidate target cells for a conditional handover. A candidate target cell for CHO may be referred to as a CHO candidate. For example, up to 8 candidate cells with associated conditional handover execution conditions may be configured for a UE 3. The number of execution conditions may be two (alternatively one execution condition, or three or more execution conditions, could conceivably be used). The UE 3 executes the CHO towards a selected target cell when the conditions are met by applying the corresponding conditional reconfigurations. This improves mobility robustness since the CHO configuration can be sent before the serving cell quality drops, and the UE 3 may avoid mobility failure due to a missed HO command.

### <Examples of L1/L2 Mobility>

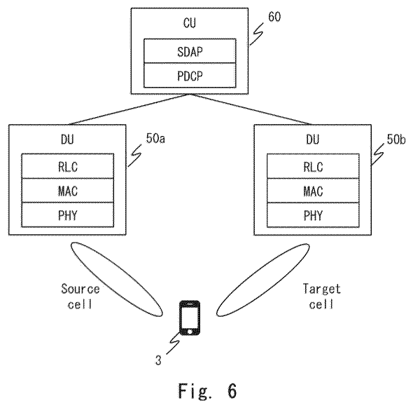

Examples of scenarios in which L1/L2 mobility methods may be used will now be described with reference to FIGS. 6 to 10.

FIG. 6 shows an example of Intra-CU inter-DU mobility.

In this case, the current serving cell and the candidate cells share the same CU. Since the source cell and the target cell are located in different DU, radio link control (RLC) layer should be re-established, and the medium access control (MAC) layer should be reset.

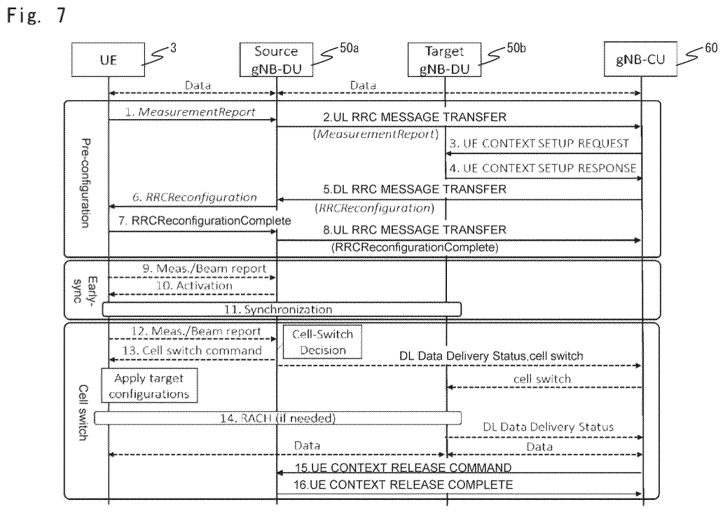

FIG. 7 shows an example corresponding to the inter-DU mobility illustrated in FIG. 6. A procedure for L1/L2-based inter-cell mobility from a source DU 50a to a target DU 50b is shown. As show in the Figure, the method comprises a pre-configuration stage, an early-synchronisation stage, and a cell switch stage, described below.

### {Pre-Configuration}

In steps 1 and 2 the UE 3 sends a L3 measurement report to the source DU 50a based on measurement configurations. The measurement report is forwarded to CU 60.

In steps 3 to 8 the CU 60 determines a candidate set for UE 3, sends a preparation request to the target DU 50b and receives a corresponding acknowledgement from target DU 50b. Then CU 60 sends the RRC reconfiguration to UE 3 and receives complete message, via source DU 50a.

### {Early Synchronisation}

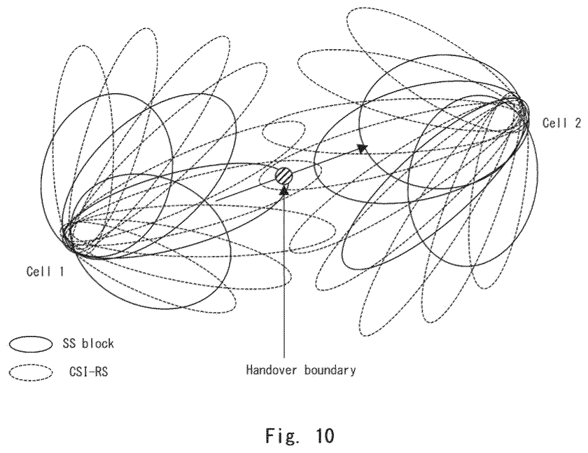

In steps 9 to 11 the UE 3 performs L1 measurements and reports for reference signals (e.g. SSB or CSI-RS illustrated in FIG. 10) corresponding to inter-cell beams, based on configurations from the network. Based on L1 measurement reports, the telecommunication system 1 may activate some transmission configuration information (TCI) states quasi co-located (QCL-ed) with cells whose physical cell ID (PCI) is different from serving cell. The UE 3 performs synchronisation (DL and optionally UL) for these cells.

### {Cell Switch}

In steps 12 to 13, based on further L1 reports, the DU 50 may indicate a target cell and beam (TCI state). The UE 3 applies target cell configurations. In step 14, if TA is not available, the UE 3 performs RACH towards the indicated target cell. In steps 15 and 16 the UE 3 receives PDCCH from target cell using new TCI state.

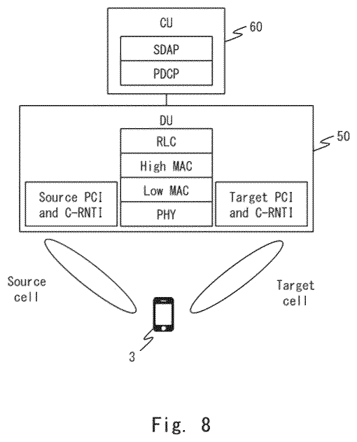

FIG. 8 shows an example of Intra-DU mobility. In this case, the current serving cell and the candidate cells share the same CU and DU. In this case, there is no need for PDCP, RLC to re-established.

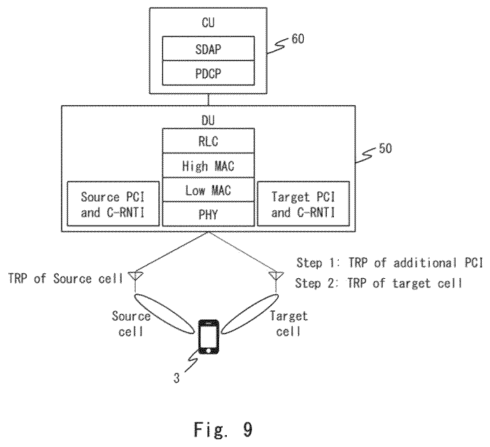

FIG. 9 shows an example of Intra-DU handover to additional physical cell ID (PCI). Within intra-DU, there is a case in which the UE 3 receives physical downlink shared channel (PDSCH) from a transmission reception point (TRP) associated with an additional PCI (different from current serving cell's PCI). In this scenario, MAC reset may not be needed.

FIG. 10 illustrates beams corresponding to first and second cells, useful for understanding examples in which methods of inter-cell beam management may be used. As shown in the figure, in this example the first and second cells comprises beams corresponding to syncronisation signal (SS) blocks, and beams corresponding to channel state information reference signals (CSI-RS). A handover boundary for a UE 3 that moves from cell 1 to cell 2 is illustrated.

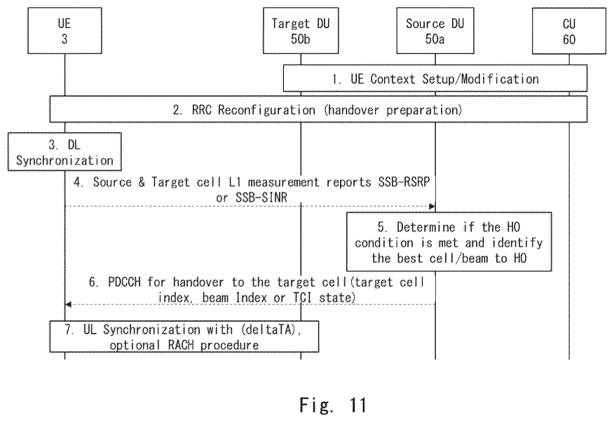

FIG. 11 shows an inter-cell inter-DU method.

In step 1, UE Context Setup/Modification is performed.

In step 2, RRC Reconfiguration (handover preparation) is performed.

In step 3, DL Synchronization is performed.

In step 4, Source & Target cell L1 measurement reports SSB-RSRP or SSB-SINR are transmitted from the UE to the source DU 50a.

In step 5, a determination of whether the HO condition is met is performed, and the best cell/beam for HO is identified.

In step 6, a physical downlink control channel (PDCCH) for handover to the target cell (which may include a target cell index, beam Index or TCI state) is transmitted from the source DU 50a to the UE 3.

Step 7 comprises UL Synchronization (which may include transmission of a delta timing advance (deltaTA) described below), and an optional RACH procedure.

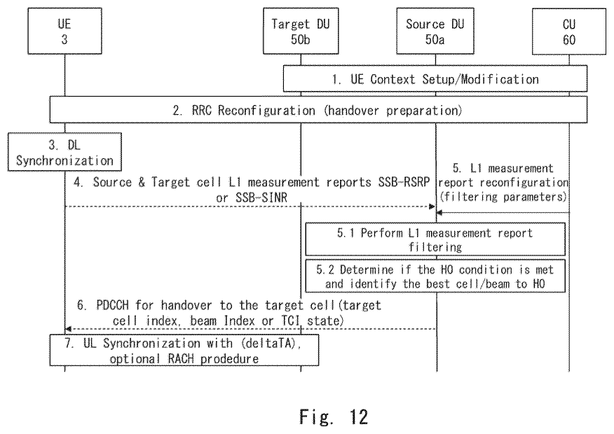

FIG. 12 shows a gNB triggered L1 mobility method including measurement report filtering.

Steps 1 to 4 of FIG. 12 correspond to steps 1 to 4 of FIG. 11.

In step 5, an L1 measurement report reconfiguration (which may include one or more filtering parameters) is transmitted from the CU 60 to the source DU 50a.

In step 5.1, L1 measurement report filtering is performed at the source DU 50a.

Step 5.2 of FIG. 12 corresponds to step 5 of FIG. 11.

Steps 6 and 7 of FIG. 12 correspond to steps 6 and 7 of FIG. 11.

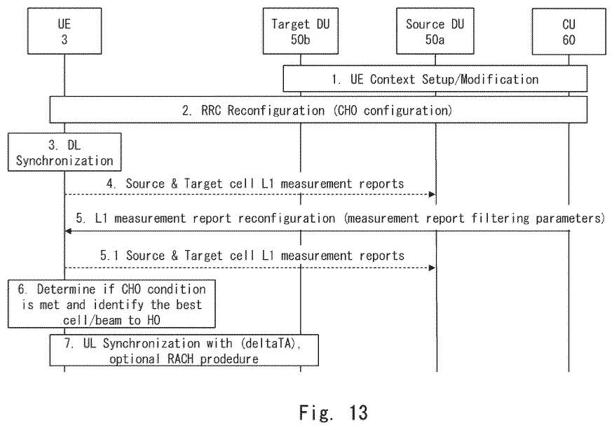

FIG. 13 shows an inter-cell inter-DU method including conditional handover.

In step 1, UE Context Setup/Modification is performed.

In step 2, RRC Reconfiguration (CHO configuration) is performed.

In step 3, DL Synchronization is performed at the UE 3.

In step 4, Source & Target cell L1 measurement reports are transmitted from the UE 3 to the source DU 50a.

In step 5, L1 measurement report reconfiguration (which may include measurement report filtering parameters) is transmitted from the CU 60 to the UE

In step 5.1, Source & Target cell L1 measurement reports are transmitted from the UE 3 to the source DU 50a.

In step 6, the UE determines if one or more CHO conditions is/are met and identifies the best cell/beam for HO.

Step 7 of FIG. 13 corresponds to step 7 of FIG. 12.

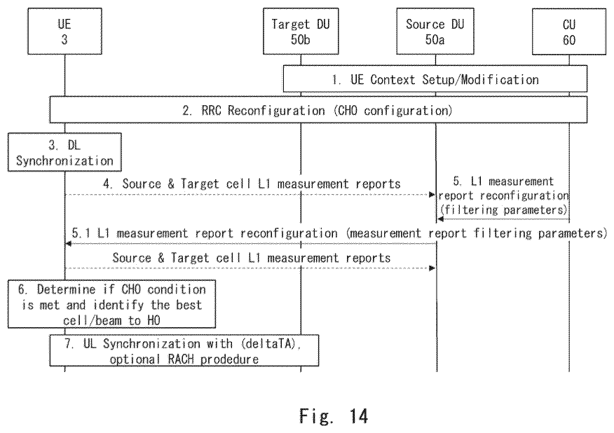

FIG. 14 shows an inter-cell inter-DU method including conditional handover including an L1 measurement report reconfiguration. As can be seen in the figure, FIG. 14 shows a modification of the method shown in FIG. 13 in which an L1 measurement report reconfiguration (which may include filtering parameters) is transmitted from the CU 60 to the source DU 50a, and the L1 measurement report reconfiguration (which may include measurement report filtering parameters, as described in more detail below) is transmitted from the source DU 50a to the UE 3. Measurement report filtering is described in more detail below.

In step 1 of FIGS. 11 to 14, handover preparation may include measurement configuration and Inter-DU synchronisation signal block (SSB) SS/PBCH Block Measurement Timing Configuration (SMTC) co-ordination. SMTC is an SSB-based measurement timing configuration.

In step 2 of FIGS. 11 to 14, RRC Reconfiguration may include measurement configuration, measurement report configuration, Target Cell List and random access channel (RACH) configuration, SMTC (Inter-DU) SSB-related information of the Target Cell and associated DU-ID, and inter-frequency measurement gap configuration. If the measurement gap is used, inter-frequency measurement may be performed from OFDM symbols corresponding to the overlapped time span between SMTC window duration and the measurement gap, as defined by higher layer for the minimum measurement time.

In step 4 of FIGS. 11 to 14, it is noted that SSB based radio link monitoring (RLM), beam management (BM) and beam failure recovery (BFR) may be outside an active bandwidth part (BWP). A beam measurement report may contain a candidate cell ID, or use implicit mapping of beam index to a neighbour cell and hence the associated DU-ID.

If handover does not occur upon timer expiry, the source cell may initiate L1 beam measurement reporting again via PDCCH that includes a one bit ‘start/stop’ indication.

In FIGS. 11 to 14, the DCI may indicate the new target beam Index or TCI state.

As described in more detail below, the UL TA offset (delta TA) may be estimated from the downlink tracking reference signal of the source and candidate target cells. Inter-cell TRS tracking may be performed after receiving the target cell indication.

### <Measurement Report Timer>

Periodic reporting by the UE (e.g. as part of one of the methods illustrated in FIGS. 11 to 14) is supported for both L3 and L1 measurements. However, whilst the reporting period for L3 measurements may range from 120 ms to 30 minutes, the reporting period for L1 measurements is shorter and may range from 4 slots to 320 slots. For example, for 120 kHz subcarrier spacing, 320 slots corresponds to 40 ms. The short periodicity of the L1 measurements in inter-cell handover increases the signalling overhead and energy consumption of the UE, due to the number of measurements and amount of reporting performed for the candidate cells. This problem becomes worse if the handover is delayed, for example because the UE stops moving or the target cell radio link does not improve further. In this example, a timer is used to mitigate against this problem.

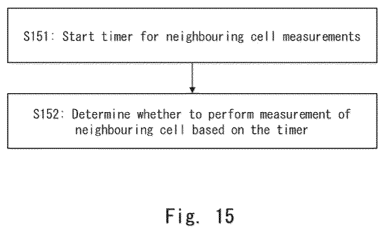

FIG. 15 shows a flow diagram of a method of a UE 3 that utilises a timer for neighbouring cell SSB measurements.

In step S151, the UE 3 starts a timer for neighbouring cell measurements. The timer may be started in response to receiving a mobility configuration (e.g. from a base station 5). The neighbouring cell measurements may be SSB measurements for use in an L1/L2 mobility procedure. The timer (e.g. starting or stopping of the timer) may be configured by the base station 5. The ‘UE measurements’ or ‘neighbouring cell measurements’ may also be referred to as ‘L1/L2 mobility monitoring’ (this also applies to the further examples described below).

In step S152, the UE 3 determines whether to perform a measurement of a neighbouring cell, based on the status of the timer. If the time has expired and no HO has been triggered, the UE stops measurements of the neighbouring cells. If the time has not expired and no HO has been triggered, the UE 3 performs one or more measurements of neighbouring cells (and may transmit a corresponding measurement report to the base station 5).

Advantageously, the use of timer significantly reduces the energy consumption of the EU, and reduces the overall measurement resources needed for L1/L2 handover, by reducing the number of measurements of the neighbouring cells performed by the UE 3.

### <Measurement Start/Stop Indication>

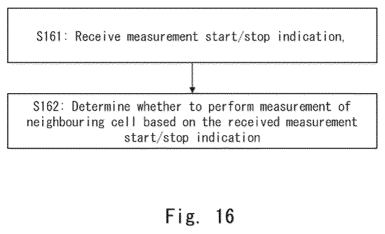

FIG. 16 shows a flow diagram of a method of a UE 3 that receives a start/stop indication for neighbouring cell SSB measurements. In this example, the start/stop indication is used to control the number of neighbouring cell measurements, to reduce the signalling overhead and energy consumption of the UE.

In step S161 the UE 3 receives the measurement start/stop indication (or restart indication). The UE 3 may receive the start/stop indication from the base station 5 (e.g. from the source DU 50a, for example in any suitable transmission shown in FIGS. 11 to 14). The start/stop indication may comprise a ‘start’ indication that indicates that the UE 3 is to begin measurements of one or more (or all) neighbouring cells, or a ‘stop’ indication that indicates that the UE 3 is to stop performing measurements of one or more (or all) neighbouring cells.

The base station 5 may determine to transmit the start/stop indication to the UE 3 based on, for example, a timer since a mobility configuration was transmitted to the UE 3 (e.g. transmit a stop indication if the timer has expired and no HO has occurred). The base station 5 may alternatively (or additionally) determine to transmit the start/stop indication to the UE 3 based on L3 reference signal received power (RSRP) measurements. The base station 5 may determine to transmit the start/stop indication based on neighbouring cell measurements performed at the UE 3.

The start/stop indication may be transmitted to the UE via physical downlink control channel (PDCCH).

### <Measurement Strength>

As described above, there is a problem that the short periodicity of the L1 measurements in inter-cell handover increases the signalling overhead and energy consumption of the UE due to the number of measurements and corresponding reporting performed for the candidate cells. In this example, a measurement threshold is used to mitigate against this problem.

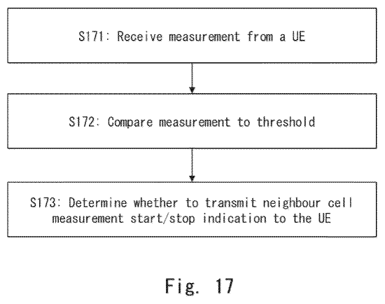

FIG. 17 shows an example in which a base station 5 receives a measurement from a UE 3, compares the received measurement to a threshold value, and determines whether to transmit a start/stop indication (e.g. the start stop indication described above) for measurement reporting to the UE based on the comparison of the received measurement to the threshold value.

In step S171 the UE 3 receives a measurement from a UE 3 (e.g. information included in a measurement report in step 4 shows in FIGS. 11 to 14).

In step S172 the base station 5 compares the received measurement to a threshold value. The comparison may be a comparison of a signal strength or signal quality measured by the UE 3 to a corresponding threshold signal strength or threshold signal quality. The comparison in step S172 may be between a signal strength or signal quality measured by the UE 3 and the highest signal strength or signal quality previously measured by the UE 3 (in other words, the threshold may correspond to the highest signal strength or signal quality measured by the UE 3). In order to restart the measurements at the UE 3, a comparison with an L3 measurement threshold may be used.

In step S173 the base station 5 determines whether to transmit the start/stop indication (or restart indication) for neighbour cell measurement to the UE based on the comparison between the received measurement and the threshold.

Advantageously, use of the threshold at the base station 5 (and the corresponding transmission of the measurement start/stop indication to the UE 3) significantly reduces the energy consumption of the EU, and reduces the overall measurement resources needed for L1/L2 handover.

### <Candidate Cell List>

In this example, a candidate cell list is used to mitigate against the problem of increased signalling overhead and energy consumption of the UE due to the number of measurements and corresponding reporting performed for the candidate cells.

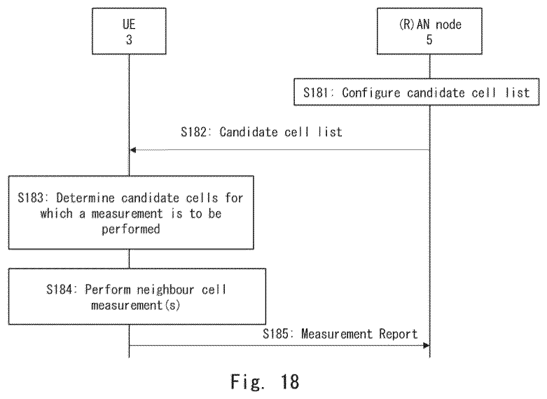

FIG. 18 shows a flow diagram of a method that includes transmitting a list of candidate cells for inter-cell beam measurement, for conditional handover.

In step S181 the candidate cell list is configured by the base station 5. The candidate cell list may include a global cell identity and tracking area code for each of the candidate target cells. The candidate cell list may indicate a subset of the candidate cells for which the UE 3 is to perform measurements (L1/L2 mobility monitoring). For example, the candidate cell list may indicate that the two best targets cells (e.g. cells previously determined to have the highest received signal strength or best signal quality) are to be measured, and/or that the other cells in the candidate cells list are not to be measured. In other words, the base station 5 may select a subset of the candidate cells for which the UE 3 is to perform measurements, and the configure the candidate cell list so that the UE 3 can identify that subset of cells based on the candidate cell list. The candidate cell list may be configured in order of priority for UE 3 measurement (in other words, the candidate cell list may be ranked). The UE 3 may be configured to perform measurements for, for example, the two cells having the highest priority for L1/L2 mobility monitoring. The UE 3 may perform the measurements of the candidate cells either one or several at time (simultaneously).

Alternatively, the indication of the cells for which measurements are to be performed may be transmitted separately from the candidate cell list. For example, each cell in the candidate cell list may be associated with a corresponding index, and the base station 5 may separately transmit, to the UE 3, the indices corresponding to the subset of cells for which measurements are to be performed. The indication of the cells for which the UE 3 is to perform the measurements (which may be the candidate cell list itself) may be transmitted in any suitable transmission illustrated in FIGS. 11 to 14 (e.g. in any suitable transmission from the source DU 50a) to the UE 3, such as part of the RRC Reconfiguration step. The base station 5 may select the cells for which measurements are to be performed by the UE 3 based on a capability of the UE 3, or based on an intended (or required) power saving to be achieved at the UE 3.

In step S182 the UE 3 receives, from the base station 5, the list of candidate cells for handover.

In step S183 the UE 3 determines, based on the information received from the base station 5, the candidate cells for which a measurement is to be performed. In step S184 the UE performs the corresponding measurements of the candidate cells, and in step S185 the UE 3 transmits a corresponding measurement report to the base station 5. The UE 3 may include an indication of the cell indices or beam indices associated with the cells that were measured, in the measurement report transmitted to the base station 5.

### <Measurement Report Filtering>

As described above the reporting period for L1 measurements is short, which can result in increased power consumption at the UE. However, there is an additional problem that the short periodicity of L1 measurements can increase the probability of ping-pong handover occurring. Methods of mitigating against this problem using handover performance and measurement report filtering will now be described.

L1 filtering comprises filtering of the inputs (measurements) measured at a UE 3, and includes measurement averaging.

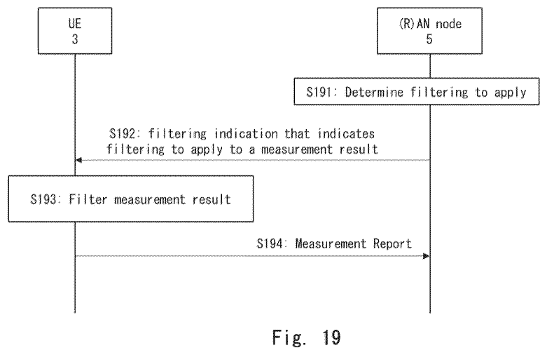

FIG. 19 shows a flow diagram of a method at a UE 3 that includes measurement report filtering.

In step S191, the base station 5 determines a filtering to be used as the UE 3 to filter a signal measurement. Advantageously, the base station 5 may determine the filtering to be used at the UE 3 based on a handover performance (particularly in the example of CHO). The base station 5 may determine the filtering to be used at the UE 3 based on a handover failure rate of the UE 3, occurrence of pingpong handover (consecutive handovers occur between a pair of cells, and the time of stay is less than a certain threshold), rapid handover (similar to pingpong, but involving three cells, in which the staying time in the target cell after each handover is shorter than a threshold duration), handover that occurs too early (TooEarlyHandover), handover that occurs too late (TooLateHandover), or handover that has occurred to a wrong (incorrect) cell (HandOverToWrongCell).

The base station 5 may configure any suitable parameter of the measurement filtering to be used at the UE 3. For example, the base station 5 may determine the number of measurements to average, the best n measurements to average, or the number of measurement events exceeding a threshold during a configuration time period (L1 measurement period) to be used as a trigger for measurement reporting. The base station 5 may determine that arithmetic averaging of signals measured at the UE 3 should be used. Alternatively, the base station 5 may determine that any other suitable formula or equation is to be used at the to filter measurements obtained at the UE 3. For example, an L3 filtering formula may be used after pre-processing of the measurement samples, for example after removing the highest and/or lowest measurement values. The formula may be, for example:

$${F}_{n} = ( 1 - a ) {F}_{n - 1} + ( a * {M}_{n} ) ,$$

where ‘Mn’ is the most recent measurement at the UE 3, ‘a’ is the filter coefficient, ‘Fₙ’ is the filtered value and ‘Fₙ₋₁’ is the previous filtered value.

In step S192, the UE 3 receives a filtering indication that indicates filtering to apply to a measurement result.

In step S193, the UE 3 filters a measurement result using the filtering.

In step S194, the UE 3 transmits a corresponding measurement report to the base station 5.

In this example L1 filtering of the measurements performed by the UE is implemented at the UE, but additionally (or alternatively) filtering may be performed at the base station. For example, in step S191 may determine filtering at the base station 5 to applying to the measurements obtained by the UE 3, and rather than transmitting the filtering indication to the UE 3, the base station may simply receive the measurements from the UE 3 and apply the filtering at the base station 5 (e.g. at the source DU 50a illustrated in the examples shown in FIGS. 1 to 14)

### <Time Advance (TA)>

UL TA offset (delta TA) may be estimated from the downlink tracking reference signal of the source and candidate target cells. Inter-cell TRS tracking may be performed after receiving the target cell indication.

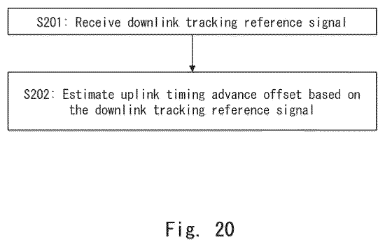

FIG. 20 shows an example in which UL TA offset is estimated at a UE 3 based on a downlink tracking reference signal. The UL TA offset may be used as the deltaTA shown in step 7 of FIGS. 11 to 14.

In step S201, the UE 3 receives a downlink tracking reference signal.

In step S202, the UE 3 estimates an uplink timing advance offset based on the downlink tracking reference signal (which may then be used as the UL TA offset may be used, for example, as the deltaTA shown in step 7 of FIGS. 11 to 14).

Advantageously, the determination of the UL TA offset reduces the HO interruption time.

Inter-cell Tracking Reference Signal (TRS) tracking may be performed, for example, after the UE 3 has received the handover target cell indication.

### Modifications and Alternatives

Detailed embodiments have been described above. As those skilled in the art will appreciate, a number of modifications and alternatives can be made to the above embodiments whilst still benefiting from the present disclosure embodied therein. By way of illustration only a number of these alternatives and modifications will now be described.

Some or all of the above described methods are applicable to the following scenarios:
Standalone, carrier aggregation (CA), and new radio dual connectivity (NR-DC) case with serving cell change within one configured grant (CG)
intra-distributed unit (intra-DU) case and intra centralised unit (intra-CU) inter-DU case (for standalone and CA)
intra-frequency and/or inter-frequency
frequency range 1 (FR1) and frequency range 2 (FR2)
Scenarios in which the source and target cells are synchronised
Scenarios in which the source and target cells are non-synchronised

Whilst a base station of a 5G/NR communication system is commonly referred to as a New Radio Base Station (‘NR-BS’) or as a ‘gNB’ it will be appreciated that they may be referred to using the term ‘eNB’ (or 5G/NR eNB) which is more typically associated with Long Term Evolution (LTE) base stations (also commonly referred to as ‘4G’ base stations). 3GPP TS 38.300 V16.7.0 and TS 37.340 V16.7.0 define the following nodes, amongst others:
gNB: node providing NR user plane and control plane protocol terminations towards the UE, and connected via the NG interface to the 5G core network (5GC).
ng-eNB: node providing E-UTRA user plane and control plane protocol terminations towards the UE, and connected via the NG interface to the 5GC.
En-gNB: node providing NR user plane and control plane protocol terminations towards the UE, and acting as Secondary Node in E-UTRA-NR Dual Connectivity (EN-DC).
NG-RAN node: either a gNB or an ng-eNB.

It will be appreciated that the above embodiments may be applied to both 5G New Radio and LTE systems (E-UTRAN). A base station (gateway) that supports E-UTRA/4G protocols may be referred to as an ‘eNB’ and a base station that supports NextGeneration/5G protocols may be referred to as a ‘gNBs’. It will be appreciated that some base stations may be configured to support both 4G and 5G protocols, and/or any other 3GPP or non-3GPP communication protocols.

Each cell may have an associated ‘NR Cell Global Identifier’ (NCGI) to identify the cell globally. The NCGI is constructed from the Public Land Mobile Network (PLMN) identity (PLMN ID) the cell belongs to and the NR Cell Identity (NCI) of the cell. The PLMN ID included in the NCGI is the first PLMN ID within the set of PLMN IDs associated to the NR Cell Identity in System Information Block Type 1 (SIB1). The ‘gNB Identifier’ (gNB ID) is used to identify a particular gNB within a PLMN. The gNB ID is contained within the NCI of its cells. The ‘Global gNB ID’ is used to identify a gNB globally and it is constructed from the PLMN identity the gNB belongs to and the gNB ID. The Mobile Country Code (MCC) and Mobile Network Code (MNC) are the same as included in the NCGI.

In the above description, the UE and the access network node (base station) are described for ease of understanding as having a number of discrete modules (such as the communication control modules). Whilst these modules may be provided in this way for certain applications, for example where an existing system has been modified to implement the present disclosure, in other applications, for example in systems designed with the inventive features in mind from the outset, these modules may be built into the overall operating system or code and so these modules may not be discernible as discrete entities. These modules may also be implemented in software, hardware, firmware, or a mix of these.

Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like. Various other modifications will be apparent to those skilled in the art and will not be described in further detail here.

The memories shown above may be formed by a volatile memory or a nonvolatile memory, however, the memories may be formed by a combination of a volatile memory and a nonvolatile memory.

In the above embodiments, a number of software modules were described. As those skilled in the art will appreciate, the software modules may be provided in compiled or un-compiled form and may be supplied as a signal over a computer network, or on a recording medium. Further, the functionality performed by part or all of this software may be performed using one or more dedicated hardware circuits. However, the use of software modules is preferred as it facilitates updating of functionalities.

A software to configure the software modules can be stored using various types of non-transitory computer readable media to be supplied to a computer. The non-transitory computer readable media include various types of tangible storage media. Examples of the non-transitory computer readable medium include a magnetic recording medium (for example, a flexible disk, a magnetic tape, or a hard disk drive), an optical magnetic recording medium (for example, a magneto-optical disk), a CD-ROM (read only memory), a CD-R, a CD-R/W, and a semiconductor memory such as a mask ROM, a programmable ROM (PROM), an erasable PROM (EPROM), a flash ROM, or a random access memory (RAM). In addition, the program may be supplied to the computer by various types of transitory computer readable media. Examples of the transitory computer readable media include electric signals, optical signals, and electromagnetic waves. The transitory computer readable medium can supply the program to the computer via a wired communication path such as an electric wire and an optical fiber, or a wireless communication path.

The above embodiments are also applicable to ‘non-mobile’ or generally stationary user equipment. The above-described mobile device (UE) may comprise an MTC/IoT device, a power saving UE, and/or the like.

The User Equipment 3 (or “UE”, “mobile station”, “mobile device” or “wireless device”) in the present disclosure is an entity connected to a network via a wireless interface.

It should be noted that the present disclosure is not limited to a dedicated communication device, and can be applied to any device having a communication function as explained in the following paragraphs.

The terms “User Equipment” or “UE” (as the term is used by 3GPP), “mobile station”, “mobile device”, and “wireless device” are generally intended to be synonymous with one another, and include standalone mobile stations, such as terminals, cell phones, smart phones, tablets, cellular IoT devices, IoT devices, and machinery. It will be appreciated that the terms “mobile station” and “mobile device” also encompass devices that remain stationary for a long period of time.

A UE may, for example, be an item of equipment for production or manufacture and/or an item of energy related machinery (for example equipment or machinery such as: boilers; engines; turbines; solar panels; wind turbines; hydroelectric generators; thermal power generators; nuclear electricity generators; batteries; nuclear systems and/or associated equipment; heavy electrical machinery; pumps including vacuum pumps; compressors; fans; blowers; oil hydraulic equipment; pneumatic equipment; metal working machinery; manipulators; robots and/or their application systems; tools; molds or dies; rolls; conveying equipment; elevating equipment; materials handling equipment; textile machinery; sewing machines; printing and/or related machinery; paper converting machinery; chemical machinery; mining and/or construction machinery and/or related equipment; machinery and/or implements for agriculture, forestry and/or fisheries; safety and/or environment preservation equipment; tractors; precision bearings; chains; gears; power transmission equipment; lubricating equipment; valves; pipe fittings; and/or application systems for any of the previously mentioned equipment or machinery etc.).

A UE may, for example, be an item of transport equipment (for example transport equipment such as: rolling stocks; (motor) vehicles; motorcycles; bicycles; trains; buses; carts; rickshaws; ships and other watercraft; aircraft; rockets; satellites; drones; balloons etc.).

A UE may, for example, be an item of information and communication equipment (for example information and communication equipment such as: electronic computer and related equipment; communication and related equipment; electronic components etc.).

A UE may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment; video equipment; a loud speaker; a radio; a television; a microwave oven; a rice cooker; a coffee machine; a dishwasher; a washing machine; a dryer; an electronic fan or related appliance; a cleaner etc.).

A UE may, for example, be an electrical application system or equipment (for example an electrical application system or equipment such as: an x-ray system; a particle accelerator; radio isotope equipment; sonic equipment; electromagnetic application equipment; electronic power application equipment etc.).

A UE may, for example, be an electronic lamp, a luminaire, a measuring instrument, an analyser, a tester, or a surveying or sensing instrument (for example a surveying or sensing instrument such as: a smoke alarm; a human alarm sensor; a motion sensor; a wireless tag etc.), a watch or clock, a laboratory instrument, optical apparatus, medical equipment and/or system, a weapon, an item of cutlery, a hand tool, or the like.

A UE may, for example, be a wireless-equipped personal digital assistant or related equipment (such as a wireless card or module designed for attachment to or for insertion into another electronic device (for example a personal computer, electrical measuring machine)).

A UE may be a device or a part of a system that provides applications, services, and solutions described below, as to ‘internet of things’ (IoT), using a variety of wired and/or wireless communication technologies.

Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g. vehicles) or attached to animals or persons to be monitored/tracked.

It will be appreciated that IoT technology can be implemented on any communication devices that can connect to a communications network for sending/receiving data, regardless of whether such communication devices are controlled by human input or software instructions stored in memory.

It will be appreciated that IoT devices are sometimes also referred to as Machine-Type Communication (MTC) devices or Machine-to-Machine (M2M) communication devices. It will be appreciated that a UE may support one or more

IoT or MTC applications. Some examples of MTC applications are listed in the following table (source: 3GPP TS 22.368 V13.1.0, Annex B, the contents of which are incorporated herein by reference). This list is not exhaustive and is intended to be indicative of some examples of machine type communication applications.

TABLE 1

| Service Area | MTC applications |
|---|---|
| Security | Surveillance systems |
| | Backup for landline |
| | Control of physical access (e.g. to buildings) |
| | Car/driver security |
| Tracking & Tracing | Fleet Management |
| | Order Management |
| | Pay as you drive |
| | Asset Tracking |
| | Navigation |
| | Traffic information |
| | Road tolling |
| | Road traffic optimisation/steering |
| Payment | Point of sales |
| | Vending machines |
| | Gaming machines |
| Health | Monitoring vital signs |
| | Supporting the aged or handicapped |
| | Web Access Telemedicine points |
| | Remote diagnostics |
| Remote Maintenance/Control | Sensors |
| | Lighting |
| | Pumps |
| | Valves |
| | Elevator control |
| | Vending machine control |
| | Vehicle diagnostics |
| Metering | Power |
| | Gas |
| | Water |
| | Heating |
| | Grid control |
| | Industrial metering |
| Consumer Devices | Digital photo frame |
| | Digital camera |
| | eBook |

Applications, services, and solutions may be an Mobile Virtual Network Operator (MVNO) service, an emergency radio communication system, a Private Branch exchange (PBX) system, a PHS/Digital Cordless Telecommunication system, a Point of sale (POS) system, an advertise calling system, a Multimedia Broadcast and Multicast Service (MBMS), a Vehicle to Everything (V2X) system, a train radio system, a location related service, a Disaster/Emergency Wireless Communication Service, a community service, a video streaming service, a femto cell application service, a Voice over LTE (VOLTE) service, a charging service, a radio on demand service, a roaming service, an activity monitoring service, a telecom carrier/communication NW selection service, a functional restriction service, a Proof of Concept (PoC) service, a personal information management service, an ad-hoc network/Delay Tolerant Networking (DTN) service, etc.

Further, the above-described UE categories are merely examples of applications of the technical ideas and exemplary embodiments described in the present document. Needless to say, these technical ideas and embodiments are not limited to the above-described UE and various modifications can be made thereto.

Various other modifications will be apparent to those skilled in the art and will not be described in further detail here.

Part of or all the foregoing aspects can be described as in the following appendixes, but the present disclosure is not limited thereto. Some or all of elements specified in any of Supplementary Notes may be applied to various types of hardware, software, and recording means for recording software, systems, and methods.

### Supplementary Note 1

A method for a user equipment, UE, the method comprising:
receiving, from an access network node, cell information indicating candidate cells for inter-cell mobility;
performing layer 1, L1, or layer 2, L2, measurements for inter-cell mobility based on the cell information; and
transmitting a measurement report, corresponding to the L1 or L2 measurements, to the access network node;
wherein the cell information includes an indication indicating that the L1 or L2 measurements for inter-cell mobility are to be performed for a subset of the candidate cells.

### Supplementary Note 2

The method according to Supplementary Note 1, wherein
the cell information includes an indication of a number of candidate cells for which the performing the L1 or L2 measurements may be performed simultaneously by the UE.

### Supplementary Note 3

The method according to Supplementary Note 1 or 2, wherein
the cell information includes a measurement priority for each of the candidate cells; and
the method comprises:
selecting the subset of the candidate cells based on the measurement priority; and
performing the L1 or L2 measurements for the subset of the candidate cells.

### Supplementary Note 4

The method according to any one of Supplementary Notes 1 to 3, wherein the measurement report includes at least one cell index or beam index corresponding to the L1 or L2 measurements.

### Supplementary Note 5

The method according to any one of Supplementary Notes 1 to 4, wherein the indication is based on a capability of the UE or a power saving requirement of the UE.

### Supplementary Note 6

A method for a user equipment, UE, the method comprising:
receiving, from an access network node, a configuration for mobility of the UE;
starting, after receipt of the configuration, a measurement timer for layer 1, L1, or layer 2, L2, measurements for inter-cell mobility;
performing the L1 or L2 measurements; and
determining, based on a status of the measurement timer, whether to continue performing the L1 or L2 measurements.

### Supplementary Note 7

The method according to Supplementary Note 6, further comprising:
in a case where the measurement timer has been expired, and no handover has been triggered, stopping performing the L1 or L2 measurements.

### Supplementary Note 8

The method according to Supplementary Note 6 or 7, wherein
the L1 or L2 measurements are SSB measurements for an L1/L2 mobility procedure.

### Supplementary Note 9

The method according to any one of Supplementary Notes 6 to 8, further comprising:
receiving, from the access network node, a measurement indication indicating whether the L1 or L2 measurements are to be performed by the UE, wherein
the performing the L1 or L2 measurements are performed based on the measurement indication.

### Supplementary Note 10

The method according to Supplementary Note 9, wherein
the measurement indication indicates that the performing the L1 or L2 measurements are not to be performed; and
the method comprises stopping the performing the L1 or L2 measurements.

### Supplementary Note 11

The method according to any one of Supplementary Notes 6 to 10, further comprising:
transmitting, to the access network node, at least one result of layer 3, L3, measurements, and wherein
the receiving is performed based on the at least one result of the L3 measurements.

### Supplementary Note 12

The method according to Supplementary Note 11, wherein
the receiving is performed based on a comparing between a threshold value and the at least one result of the L3 measurements.

### Supplementary Note 13

The method according to Supplementary Note 12, wherein
the at least one result of the L3 measurements includes a signal strength or signal quality measured by the UE; and
the comparing between the threshold value and the at least one result of the L3 measurements includes comparing between a threshold signal strength included in the threshold value or a threshold signal quality included in the threshold value and the signal strength or the signal quality.

### Supplementary Note 14

The method according to Supplementary Note 13, wherein
the measurement indication includes an indication that the L1 or L2 measurements are to be performed by the UE, in a case where the signal strength is greater than or equals to the threshold signal strength, or the signal quality is greater than or equals to the threshold signal quality.

### Supplementary Note 15

The method according to Supplementary Note 13, wherein
the measurement indication includes an indication that the L1 or L2 measurements are to be performed by the UE, in a case where the signal strength is less than the threshold signal strength, or the signal quality is less than the threshold signal quality.

### Supplementary Note 16

The method according to any one of Supplementary Notes 12 to 15, wherein
the threshold value corresponds to a signal strength or signal quality measurement previously reported to the base station by the UE.

### Supplementary Note 17

The method according to Supplementary Note 9, wherein
the measurement indication is transmitted via physical downlink control channel, PDCCH.

### Supplementary Note 18

The method according to any one of Supplementary Notes 6 to 17, further comprising:
transmitting, to the access network node, a measurement report indicating at least one result of the L1 or L2 measurements.

### Supplementary Note 19

The method according to any one of Supplementary Notes 6 to 18, further comprising:
receiving, from the access network node, a set of timer indication that indicates that the measurement timer is to be started, stopped, or restarted; and
starting, stopping, or restarting the measurement timer based on one of the timer indication.

### Supplementary Note 20

A method for a user equipment, UE, the method comprising:
receiving, from an access network node, filtering information indicating a filtering process or filtering parameter for use at the UE to filter measurements;
performing layer 1, L1, or layer 2, L2, measurements for inter-cell mobility;
filtering the L1 or L2 measurements based on the filtering information; and
transmitting, to the access network node, a measurement report corresponding to filtered L1 or L2 measurements.

### Supplementary Note 21

The method according to Supplementary Note 20, wherein the filtering information includes at least one of:
a filtering formula, or
a number of measurements to average.

### Supplementary Note 22

The method according to Supplementary Note 20 or 21, wherein
the filtering information is based on a handover performance characteristic of the UE, and
the handover performance characteristic includes at least one of:
   a handover failure rate of the UE;
   an occurrence of pingpong handover;
   rapid handover;
   a handover that occurred too early;
   a handover that occurred too late; or a handover that occurred to an incorrect cell.

### Supplementary Note 23

A method for a user equipment, UE, the method comprising
receiving downlink tracking reference signals; and
estimating an uplink timing advance, UL TA, offset based on the downlink tracking reference signals.

### Supplementary Note 24

The method according to Supplementary Note 23, wherein
the downlink tracking reference signals include downlink tracking reference signals for a source cell and a candidate target cell for an inter-cell mobility procedure.

### Supplementary Note 25

The method according to any one of Supplementary Notes 1 to 24, wherein the L1 or L2 measurements are periodic measurements.

### Supplementary Note 26

The method according to any one of Supplementary Notes 1 to 25, wherein the L1 or L2 measurements is performed for at least one neighboring cell.

### Supplementary Note 27

A method for an access network node, the method comprising:
transmitting, to a user equipment, UE, cell information indicating candidate cells for inter-cell mobility, wherein the cell information includes an indication indicating that layer 1, L1, or layer 2, L2, measurements for inter-cell mobility are to be performed for a subset of the candidate cells; and
receiving, from the UE, a measurement report corresponding to the L1 or L2 measurements.

### Supplementary Note 28

A method for an access network node, the method comprising:
transmitting, to a user equipment, UE, a configuration for mobility of the UE; and
receiving a measurement report at a time based on when the transmitting the configuration, wherein
the configuration causes the UE to start a measurement timer for layer 1, L1, or layer 2, L2, measurements is started, and to perform the L1 or L2 measurement, and
the measurement timer causes the UE to determine, based on a status of the measurement timer, whether to continue performing the L1 or L2 measurements.

### Supplementary Note 29

A method for an access network node, the method comprising
transmitting, to a user equipment, UE, filtering information indicating a filtering process or filtering parameter for use at the UE to filter measurements; and
receiving, from the UE, a measurement report corresponding to filtered measurement, and
wherein the filtered measurement corresponds to layer 1, L1, or layer 2, L2, measurements for inter-cell mobility performed by the UE and being filtered by the UE based on the filtering information.

### Supplementary Note 30

A method for an access network node, the method comprising
receiving, from the UE, a measurement report corresponding to at least one result of layer 1, L1, or layer 2, L2, measurements for inter-cell mobility;
determining a filtering process or filtering parameter to use to filter the at least one result of the L1 or L2 measurements; and
filtering the at least one result of the L1 or L2 measurements using the filtering process or filtering parameter.

### Supplementary Note 31

A user equipment, UE, comprising:
means for receiving, from an access network node, cell information indicating candidate cells for inter-cell mobility;
means for performing layer 1, L1, or layer 2, L2, measurements for inter-cell mobility based on the cell information; and
means for transmitting a measurement report, corresponding to the L1 or L2 measurements, to the access network node;
wherein the cell information includes an indication indicating that the L1 or L2 measurements for inter-cell mobility are to be performed for a subset of the candidate cells.

### Supplementary Note 32

A user equipment, UE, comprising:
means for receiving, from an access network node, a configuration for mobility of the UE;
means for starting, after receipt of the configuration, a measurement timer for layer 1, L1, or layer 2, L2, measurements for inter-cell mobility;
means for performing the L1 or L2 measurements; and
means for determining, based on a status of the measurement timer, whether to continue performing the L1 or L2 measurements.

### Supplementary Note 33

A user equipment, UE, comprising:
means for receiving, from an access network node, filtering information indicating a filtering process or filtering parameter for use at the UE to filter measurements;
means for performing layer 1, L1, or layer 2, L2, measurements for inter-cell mobility;
means for filtering the L1 or L2 measurements based on the filtering information; and
means for transmitting, to the access network node, a measurement report corresponding to filtered L1 or L2 measurements.

### Supplementary Note 34

A user equipment, UE, comprising
means for receiving a downlink tracking reference signal; and
means for estimating an uplink timing advance, UL TA, offset based on the downlink tracking reference signal.

### Supplementary Note 35

An access network node comprising:
means for transmitting, to a user equipment, UE, cell information indicating candidate cells for inter-cell mobility, wherein the cell information includes an indication indicating that layer 1, L1, or layer 2, L2, measurements for inter-cell mobility are to be performed for a subset of the candidate cells; and
means for receiving, from the UE, a measurement report corresponding to the L1 or L2 measurements.

### Supplementary Note 36

An access network node comprising:
means for transmitting, to a user equipment, UE, a configuration for mobility of the UE; and
means for receiving a measurement report at a time based on when the transmitting the configuration, wherein
the configuration causes the UE to start a measurement timer for layer 1, L1, or layer 2, L2, measurements is started, and to perform the L1 or L2 measurement, and
the measurement timer causes the UE to determine, based on a status of the measurement timer, whether to continue performing the L1 or L2 measurements.

### Supplementary Note 37

An access network node comprising:
means for transmitting, to a user equipment, UE, filtering information indicating a filtering process or filtering parameter for use at the UE to filter measurements; and
means for receiving, from the UE, a measurement report corresponding to filtered measurement, and
wherein the filtered measurement corresponds to layer 1, L1, or layer 2, L2, measurements for inter-cell mobility performed by the UE and being filtered by the UE based on the filtering information.

### Supplementary Note 38

An access network node comprising:
means for receiving, from the UE, a measurement report corresponding to at least one result of layer 1, L1, or layer 2, L2, measurements for inter-cell mobility;
means for determining a filtering process or filtering parameter to use to filter the at least one result of the L1 or L2 measurements; and
means for filtering the at least one result of the L1 or L2 measurements using the filtering process or filtering parameter.

This application is based upon and claims the benefit of priority from United Kingdom Patent Application No. 2214449.7, filed on Sep. 30, 2022, the disclosure of which is incorporated herein in its entirety by reference.

### REFERENCE SIGNS LIST

1 TELECOMMUNICATION SYSTEM
3 USER EQUIPMENT
5 (R)AN node
6 CELL
7 CORE NETWORK
8-1 ACCESS AND MOBILITY MANAGEMENT FUNCTION
8-2 CONTROL PLANE FUNCTION
8-3 USER PLANE FUNCTION
8-4 SESSION MANAGEMENT FUNCTION
8-5 ADMINISTRATION AND MAINTENANCE FUNCTION
10 DATA NETWORK
21 TRANSCEIVER CIRCUIT
22 ANTENNA
23 CONTROLLER
24 USER INTERFACE
25 MEMORY
26 OPERATING SYSTEM
27 COMMUNICATIONS CONTROL MODULE
29 L1/L2 MOBILITY MODULE
41 TRANSCEIVER CIRCUIT
42 ANTENNA
43 NETWORK INTERFACE
44 CONTROLLER
45 MEMORY
46 OPERATING SYSTEM
47 COMMUNICATIONS CONTROL MODULE
48 L1/L2 MOBILITY MODULE
50 DISTRIBUTED UNIT
60 CENTRAL UNIT
45 TRANSCEIVER CIRCUIT
453 RU INTERFACE
454 CU INTERFACE
457 CONTROLLER
459 MEMORY
46 OPERATING SYSTEM
463 COMMUNICATIONS CONTROL MODULE
465 F1 MODULE
468 DU-RU MODULE
472 DU MANAGEMENT MODULE
473 UE PROFILE MANAGEMENT MODULE
475 L1/L2 MOBILITY MODULE
551 TRANSCEIVER CIRCUIT
554 DU INTERFACE
555 CU INTERFACE
557 CONTROLLER
559 MEMORY
561 OPERATING SYSTEM
563 COMMUNICATIONS CONTROL MODULE
565 F1 MODULE
566 E1 MODULE
568 N2 MODULE
569 N3 MODULE
571 CU-UP MANAGEMENT MODULE
572 CU-CP MANAGEMENT MODULE
573 UE PROFILE MANAGEMENT MODULE
575 L1/L2 MOBILITY MODULE

What is claimed is:

1. A method for a user equipment, UE, the method comprising:
receiving, from an access network node, configuration information for indicating candidate cells for layer 1 (L1) or layer 2 (L2) measurements;
performing the L1 or L2 measurements based on the configuration information; and
transmitting a measurement report, corresponding to the L1 or L2 measurements, to the access network node;
wherein the configuration information includes information indicating a number of candidate cells included in the measurement report corresponding to the L1 or L2 measurement.

2. (canceled)

3. The method according to claim 1, wherein
the configuration information includes a measurement priority for each of the candidate cells; and
the method further comprises:
selecting a subset of the candidate cells based on the measurement priority; and
performing the L1 or L2 measurements for the subset of the candidate cells.

4. The method according to claim 1, wherein
the measurement report includes at least one cell index or beam index corresponding to the L1 or L2 measurements.

5. The method according to claim 1, wherein
the indication is based on a capability of the UE or a power saving requirement of the UE.

6. The method according to claim 1, further comprising:
receiving, from the access network node, a configuration for mobility of the UE;
starting, after receipt of the configuration, a measurement timer for the L1 or L2 measurements; and
determining, based on a status of the measurement timer, whether to continue the performing the L1 or L2 measurements.

7. The method according to claim 6, further comprising:
in a case where the measurement timer has been expired, and no handover has been triggered, stopping performing the L1 or L2 measurements.

8. The method according to claim 6, wherein
the L1 or L2 measurements are synchronization signal/physical broadcast channel (PBCH) block (SSB) measurements for an L1/L2 mobility procedure.

9. The method according to claim 6, further comprising:
receiving, from the access network node, a measurement indication indicating whether the L1 or L2 measurements are to be performed by the UE, wherein
the performing the L1 or L2 measurements are performed based on the measurement indication.

10. (canceled)

11. The method according to claim 6, further comprising:
transmitting, to the access network node, at least one result of layer 3 (L3) measurements, and wherein
the receiving is performed based on the at least one result of the L3 measurements.

12. The method according to claim 11, wherein
the receiving is performed based on a comparing between a threshold value and the at least one result of the L3 measurements.

13. The method according to claim 12, wherein
the at least one result of the L3 measurements includes a signal strength or signal quality measured by the UE; and
the comparing between the threshold value and the at least one result of the L3 measurements includes comparing between a threshold signal strength included in the threshold value or a threshold signal quality included in the threshold value and the signal strength or the signal quality.

14-15. (canceled)

16. The method according to claim 12, wherein
the threshold value corresponds to a signal strength or signal quality measurement previously reported to the base station by the UE.

17-19. (canceled)

20. The method according to claim 1, further comprising:
receiving, from the access network node, filtering information indicating a filtering process or filtering parameter for use at the UE to filter measurements; and
filtering the L1 or L2 measurements based on the filtering information; and, wherein
the measurement report corresponds to filtered L1 or L2 measurements.

21-22. (canceled)

23. The method according to claim 1, further comprising:
receiving downlink tracking reference signals; and
estimating an uplink (UL) timing advance (TA) offset based on the downlink tracking reference signals.

24. The method according to claim 23, wherein
the downlink tracking reference signals include downlink tracking reference signals for a source cell and a candidate target cell for an inter-cell mobility procedure.

25-26. (canceled)

27. A method for an access network node, the method comprising:
transmitting, to a user equipment (UE), configuration information for indicating candidate cells for layer 1 (L1) or layer 2 (L2) measurements, wherein the configuration information includes information indicating a number of candidate cells to be included in a measurement report corresponding to the L1 or L2 measurement; and
receiving, from the UE, the measurement report corresponding to the L1 or L2 measurements.

28-30. (canceled)

31. A user equipment (UE) comprising:
at least one memory configured to store instructions; and
at least one processor configured to execute the instructions to:
receive, from an access network node, configuration information for indicating candidate cells for layer 1 (L1) or layer 2 (L2) measurements;
perform the L1 or layer 2, L2 measurements based on the configuration information; and
transmit a measurement report, corresponding to the L1 or L2 measurements, to the access network node;
wherein the configuration information includes information indicating a number of candidate cells to be included in the measurement report corresponding to the L1 or L2 measurement.

32-34. (canceled)

35. An access network node comprising:
at least one memory configured to store instructions; and
at least one processor configured to execute the instructions to:
transmit, to a user equipment (UE) configuration information for indicating candidate cells for layer 1 (L1) or layer 2 (L2) measurements, wherein the configuration information includes information indicating a number of candidate cells to be included in a measurement report corresponding to the L1 or L2 measurement; and
receive, from the UE, the measurement report corresponding to the L1 or L2 measurements.

36-38. (canceled)
